(19) United States
(12) Patent Application Publication
(10) Pub. No.: US 2009/0017663 A1
(43) Pub. Date: Jan. 15, 2009

(54) CARD PROCESSOR

(75) Inventors: Takahisa Oonishi, Tokyo (JP); Takashi Ooto, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignees: Aruze Corp., Koto-ku (JP); Seta Corp., Koto-ku (JP)

(21) Appl. No.: 12/021,840

(22) Filed: Jan. 29, 2008

(30) Foreign Application Priority Data
Feb. 2, 2007 (JP) 2007-024097

(51) Int. Cl. H01R 13/62; G06K 7/06

(52) U.S. Cl. 439/325; 235/441

(57) ABSTRACT

A card processor of the present invention has: an insertion slot, into which a card is inserted; a carriage path, along which the card inserted from the insertion slot is carried; and a shutter mechanism driven to make the insertion slot closable, wherein the shutter mechanism includes an oscillating member oscillatably supported by a shaft, the oscillating member having a closing portion, formed on one end side, configured to make the insertion slot closable and a projecting/withdrawing portion, formed on the other end side, configured to be able to project and withdraw from the carriage path, and the oscillating member is bendably formed along a card carrying direction, and the closing portion of the oscillating member in a bent state comes into contact with the surface on the rear end side of the card when the front end side of the card moving along the carriage path presses the projecting/withdrawing portion.

### CROSS-REFERENCE TO RELATED APPLICATIONS

This application claims benefit of priority based on Japanese Patent Application No. 2007-024097 filed on Feb. 2, 2007. The contents of this application are incorporated herein by reference in their entirety.

### BACKGROUND OF THE INVENTION

1. Field of the Invention

The present invention relates to a card processor that executes information writing processing and information reading processing on card-shaped information recording media, and specifically relates to a card processor characterized by a shutter mechanism being installed at a card insertion slot and blocking insertion of an additional card.

2. Discussion of the Background

The above-mentioned card processor typically comprises: a card insertion slot (hereinafter referred to as an insertion slot) into which a card is inserted; and a carriage mechanism which carries the card inserted into the insertion slot to a predetermined processing position. In such a card processor, for example, as disclosed in JP-A 2004-152240, a shutter mechanism is provided so as to prevent erroneous insertion of an additional card during processing after a user has inserted a card into the insertion slot.

The shutter mechanism disclosed in JP-A 2004-152240 is oscillatably fixed to a shaft arranged as opposed to a card carriage plane, and has a plate-shaped member (oscillating member), each end of which being bent toward the card carriage plane. The plate-shaped member is oscillatable in the form of a seesaw with the shaft at the center, and when a card inserted from the insertion slot is carried toward the inside, the front end of the card is engaged with the bent portion on one end of the plate-shaped member, and the bent portion on this end is thus lifted and oscillated with the shaft as the center. Thereby, the bent portion on the other end (insertion slot side) of the plate-shaped member is lowered, and hence the insertion slot is closed by the bent portion on the other end of the plate-shaped member, coming into a state where insertion of an additional card is prevented.

The contents of JP-A 2004-152240 are incorporated herein by reference in their entirety.

### SUMMARY OF THE INVENTION

In the card processor disclosed in JP-A 2004-152240 described above, the length of the above-mentioned plate-shaped member is set longer than the length of a card in the carrying direction so as to prevent the inserted card from being damaged by the plate-shaped member. Namely, since the plate-shaped member is set so as not to come into contact with the card when the bent portion formed at the end of the plate-shaped member on the insertion slot side is lowered, the processor body becomes long in the card carrying direction; thereby causing an increase in size of the processor body.

The present invention was made with attention focused on the above-mentioned problem, and has an object to provide a card processor the whole of which can be reduced in size by reduction in size of the shutter mechanism in the card carrying direction.

In order to attain the above object, a card processor recited in claim 1 comprises: an insertion slot, into which a card is inserted; a carriage path, along which the card inserted from the insertion slot is carried; and a shutter mechanism driven to make the insertion slot closable, wherein the shutter mechanism includes an oscillating member oscillatably supported by a shaft, the oscillating member having a closing portion, formed on one end side, configured to make the insertion slot closable and a projecting/withdrawing portion, formed on the other end side, configured to be able to project and withdraw from the carriage path, and the oscillating member is bendably formed along a card carrying direction and the closing portion of the oscillating member in a bent state comes into contact with the surface on the rear end side of the card when the front end side of the card moving along the carriage path presses the projecting/withdrawing portion.

According to the card processor having the above-mentioned configuration, when a card is inserted into an insertion slot and then carried, the front end side of the card is engaged with the projecting/withdrawing portion formed on the other end side (processor body interior side) of the oscillating member, to oscillate the oscillating member. With the oscillating member oscillated, the insertion slot is closed by the closing portion formed on the end side (insertion slot side) of the oscillating member, coming into a state where insertion of an additional card is prevented. Further, even when the closing portion formed on the oscillating member moves in a direction to close the insertion slot and comes into contact with the surface of the card being carried before passage of the rear end of the card being carried through the insertion slot, the oscillating member is bent to alleviate contact force at the time of the closing portion coming into contact so as to prevent damage on the card surface. This eliminates the need for adjusting the length of each end of the oscillating member based upon the length of the card in the carrying direction, thereby allowing reduction in size of the processor body.

Further, the invention according to claim 2 is characterized in that the length of the oscillating member is set shorter than the length of the card in the carrying direction.

According to the card processor having the above-mentioned configuration, since the length of the oscillating member is set shorter than the length of the card in the carrying direction, it is possible to further reduce the processor body in size.

Moreover, the invention according to claim 3 is characterized in that a notched depression is formed between the closing portion and the projecting/withdrawing portion in the oscillating member.

According to the card processor having the above-mentioned configuration, formation of a notched depression can further facilitate bending of the oscillating member. Namely, the contact force of the closing portion on the card can be reliably alleviated, to reliably prevent damage on the card surface.

Furthermore, the present invention according to claim 4 is characterized in that the card processor further comprises a carriage mechanism which carries a card on the carriage path, wherein the carriage mechanism is capable of carrying the card toward the insertion slot side, and an inclined face rising toward the insertion slot side is formed on the closing portion.

According to the card processor having the above-mentioned configuration, it is possible to return a card toward the insertion slot side even in a state where the closing portion is closing the insertion slot. Namely, when a card inserted inside from the insertion slot is returned or a card housed inside the processor body is issued, the returned card can be carried along the inclined face even with the insertion slot closed by the closing portion.

Additionally, the invention according to claim 5 is characterized in that the carriage path has a contact portion that comes into contact with the closing portion from inside, when the oscillating member closes the insertion slot.

According to the card processor having the above-mentioned configuration, when a card is inserted inside the processor body and the closing portion of the oscillating member closes the insertion slot, the closing portion comes into the state of being enforced by the contact portion that comes into contact from inside, thereby enabling an increase in strength of the closing operation of the closing portion against insertion of an additional card.

According to the present invention, it is possible to obtain a card processor whose body can be reduced in size in a card carrying direction.

### BRIEF DESCRIPTION OF THE DRAWINGS

FIG. 1 is a view showing a configuration of a card processor, as well as a plan view showing a whole configuration.

FIG. 2 is a view showing a state where a stock portion has been opened.

FIG. 3 is a view showing a state where the substrate installation frame has been removed from the state shown in FIG. 2, as well as a view showing a configuration of a card carriage path.

FIG. 4 is an enlarged view of the card insertion slot portion shown in FIG. 3.

FIG. 5 is a view of the card processor seen from the rear side.

FIG. 6 is an enlarged view of main parts of FIG. 5.

FIG. 7 is a perspective view showing a configuration of an oscillating member (first oscillating member) constituting a shutter mechanism.

FIG. 8 is a view showing an operation of the oscillating member when a card moves from the insertion slot (Part 1).

FIG. 9 is a view showing an operation of the oscillating member when the card moves from the insertion slot (Part 2).

FIG. 10 is a view showing an operation of the oscillating member when the card moves from the insertion slot (Part 3).

FIG. 11 is a view showing an operation of the oscillating member when the card moves from the insertion slot (Part 4).

FIG. 12A is a view showing a configuration of a roller, and FIG. 12B is a view showing a modified example of the roller.

FIG. 13 is an enlarged perspective view of a fixing member that supports a roller constituting a carriage mechanism.

FIG. 14 is a view showing a state where the roller is held between a pair of fixing members.

FIG. 15A and FIG. 15B are views each showing a fixing member in which the position of the central shaft holding portion has been changed.

FIG. 16 is a view of a stock portion seen from the insertion slot side.

FIG. 17 is a view showing a state where a card is housed in the stock portion.

FIG. 18A is a plan view showing a configuration of an oscillating member (second oscillating member) that constitutes a housing drive mechanism, and FIG. 18B is a side view thereof.

FIG. 19 is a view showing functions of the second oscillating member and the stock portion when the card is carried from the insertion slot (Part 1).

FIG. 20 is a view showing functions of the second oscillating member and the stock portion when the card is carried from the insertion slot (Part 2).

FIG. 21 is a view showing functions of the second oscillating member and the stock portion when the card is carried from the insertion slot (Part 3).

FIG. 22 is a view showing functions of the second oscillating member and the stock portion when the card is carried from the insertion slot (Part 4).

FIG. 23 is a view showing functions of the second oscillating member and the stock portion when the card is carried from the stock portion toward the insertion slot (Part 1).

FIG. 24 is a view showing functions of the second oscillating member and the stock portion when the card is carried from the stock portion toward the insertion slot (Part 2).

FIG. 25 is a view showing functions of the second oscillating member and the stock portion when the card is carried from the stock portion toward the insertion slot (Part 3).

FIG. 26 is a view showing a state where the card is held at the insertion slot by the second oscillating member.

FIG. 27 is a perspective view showing a state where the card is held at the insertion slot by the second oscillating member.

FIG. 28 is a view showing another example of the projecting/withdrawing portion that holds the card at the insertion slot.

FIG. 29A is a plan view showing a modified example of the second oscillating member, and FIG. 29B is a side view thereof.

FIG. 30A is a cross-sectional view along the A-A line of FIG. 29A, and FIG. 30B is a cross-sectional view along the B-B line of FIG. 29A.

FIG. 31 is a front view of the second oscillating member, as well as a view showing the state of incorporating a roller.

### DESCRIPTION OF THE EMBODIMENTS

In the following, an embodiment of a card processor according to the present invention is described with reference to drawings. It is to be noted that a card processor in the present embodiment has such a configuration as to be suitably installed mainly in a game media lending machine in a recreation hall such as a pachinko hall. Namely, the card processor in the present embodiment is configured to be able to: read and rewrite amount-of-money information by insertion of a card (prepaid card) with amount-of-money information written therein; return a card with rewritten amount-of-money information or collect a card when the amount becomes zero; and write amount-of-money information into a card previously in stock by insertion of an amount of money, to issue the card (prepaid card).

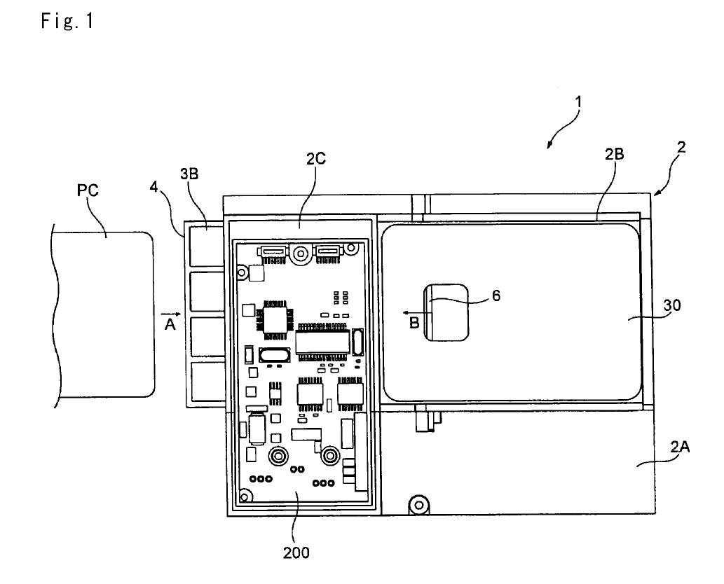

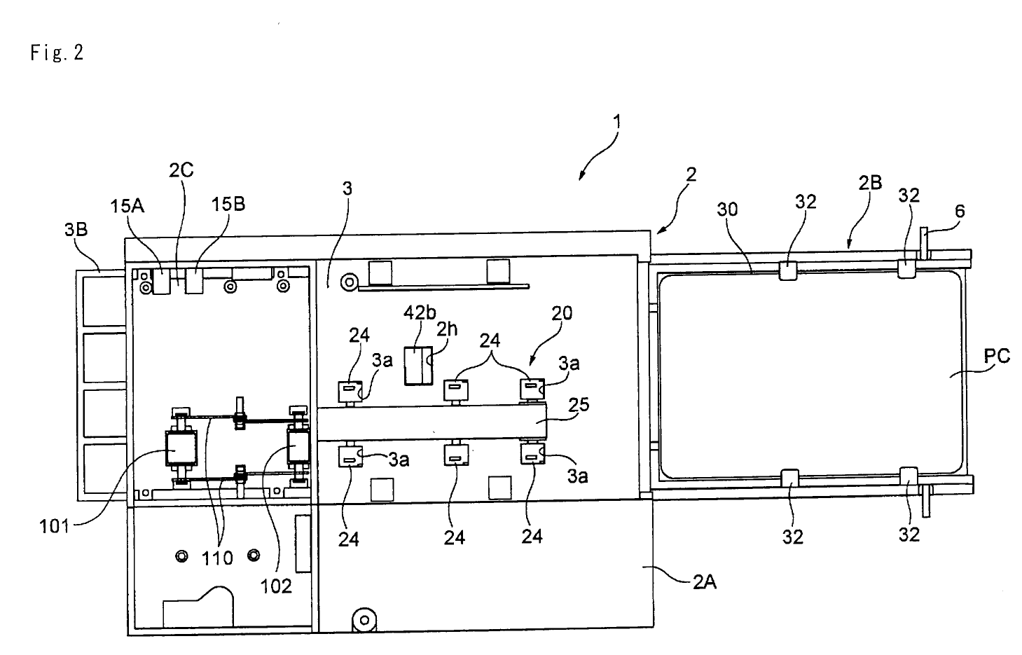

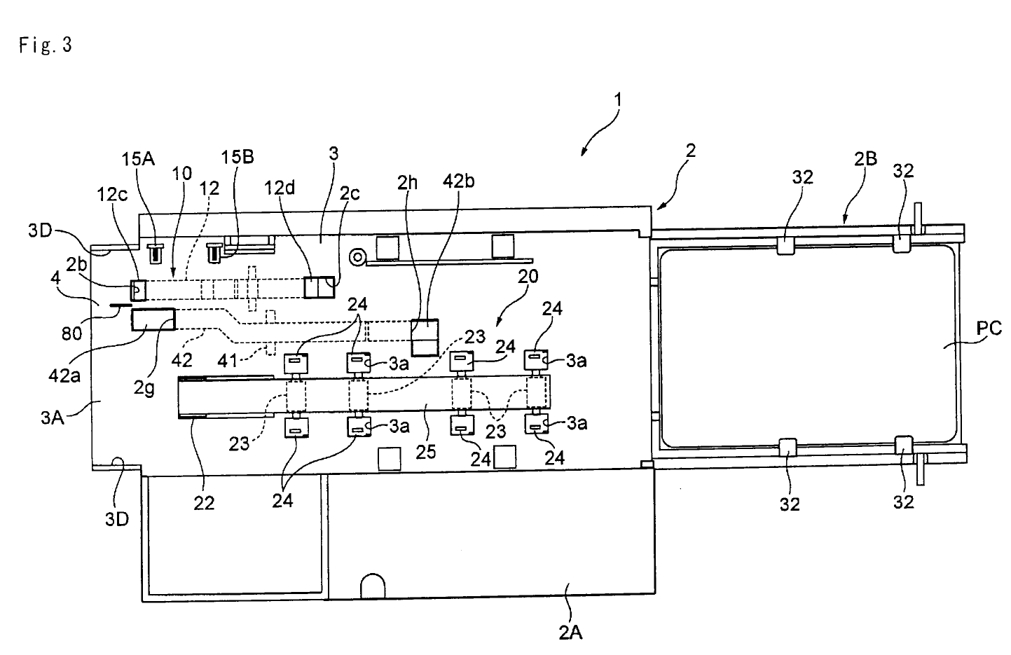

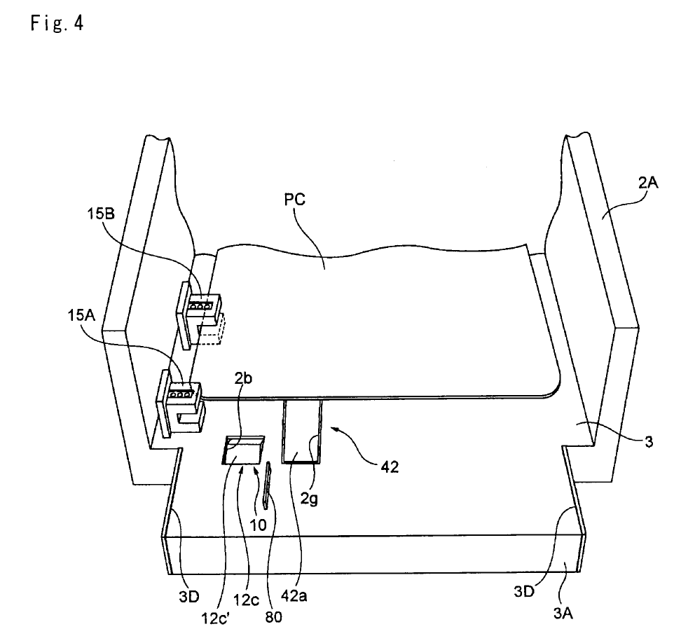

FIG. 1 to FIG. 6 are views showing configurations of the card processor. FIG. 1 is a plan view showing a whole configuration, FIG. 2 is a view showing a state where a stock portion has been opened from the state shown in FIG. 1, FIG. 3 is a view showing a state where the substrate installation frame has been removed from the state shown in FIG. 2, as well as a view showing a configuration of a card carriage path, FIG. 4 is an enlarged view of the card insertion slot portion shown in FIG. 3, and FIG. 5 is a view of the card processor seen from the rear side.

A card processor 1 of the present embodiment is for example configured so as to be incorporated into a game media lending machine (not shown) installed between a variety of gaming machines such as pachinko machines and slot machines.

In this case, other devices (e.g. bill processor, a power unit, and the like) may be previously installed on the upper side or the lower side with respect to the card processor 1 in the game media lending machine; the card processor 1 may be integrated with these other devices, or may be configured separately therefrom. While executing prepaid card reading processing and return processing/collect processing as described above, the card processor 1 is capable of executing card issuance processing by insertion of a bill into a bill processor which is not shown.

The card processor 1 comprises a frame 2 formed in the shape of a substantially rectangular prism, and this frame 2 is mounted on a locking portion of a game media lending machine which is not shown. The frame 2 has: a body frame 2A constituting a processor body; a stock portion 2B which is configured to stack and house a plurality of cards and installed on the card carriage downstream side of the body frame 2A; and a substrate mounted frame 2C which is installed on the card carriage upstream side of the body frame 2A and has a control substrate 200 mounted thereon for controlling the whole processor. It is to be noted that, although FIG. 1 shows the state of the control substrate 200 being exposed, the control substrate 200 is actually in the state of being covered by a cover which is not shown.

As shown in FIG. 1 and FIG. 2, the stock portion 2B is configured to be opened from and closed into the body frame 2A with a base as its rotational center. Other than being mounted with the control substrate 200, the substrate mounted frame 2C rotatably holds rollers 22, 23 constituting a later-described carriage mechanism, a plurality of pinch rollers 101, 102 in contact with a carriage belt 25, and the like. It is to be noted that a torsion spring 110 is arranged between a shaft of the pinch roller 101 and a shaft of the pinch roller 102, and the pinch rollers 101, 102 are biased toward the rollers 22, 23 and the carriage belt 25 side.

The body frame 2A has the shape of a substantially rectangular prism, and at its center, a carriage path 3 is formed which extends in a longitudinal direction to carry a card. As shown in FIG. 4, a card PC is to be carried along this carriage path 3, the stock portion 2B is closed into the body frame 2A and the substrate mounted frame 2C is immovably attached to the body frame 2A, to form a gap for carriage of a card, forming the carriage path 3. Therefore, this carriage path 3 is typically arranged not to be exposed to the outside.

Card carrying-in portions 3A, 3B are formed respectively on the body frame 2A and the substrate mounted frame 2C, so as to agree with the carriage path 3. When the stock portion 2B is closed into the body frame 2A and the substrate mounted frame 2C is mounted on the body frame 2A, the card carrying-in portions 3A, 3B form a slit-shaped card insertion slot 4. As shown in FIG. 1, the card PC is inserted inside at the slit-shaped insertion slot 4 along a direction of an arrow A. It should be noted that control walls 3D for controlling both sides of the card inserted from the insertion slot 4 are formed on the card carrying-in portions 3A, 3B, and the card is guided onto the carriage path 3 in the state of being positioned by the control walls 3D.

The stock portion 2B is provided with the function of stocking cards carried in onto the carriage path 3 from the insertion slot 4, and cards that move along the carriage path 3 are housed so as to be sequentially stacked from the bottom of the stock portion. It is to be noted that a specific configuration and operation of the stock portion 2B are described later.

The front edge side of the stock portion 2B is provided with a lock shaft 6 that can be latched to the body frame 2A. This lock shaft 6 is biased toward the rear side by a bias spring or the like. Pulling the lock shaft 6 toward the insertion slot 4 side (direction of an arrow B) releases the locked state of the stock portion 2B and the body frame 2A (both frames being in the closed state) so that the stock portion 2B comes into an open state (see FIG. 2).

In the body frame 2A, there are installed a shutter mechanism for preventing insertion of an additional card, a carriage mechanism for carrying a card, a housing drive mechanism for housing a card moving along the carriage path 3 into the stock portion 2B, a drop prevention mechanism for holding a card so as to prevent the card from dropping when a card is discharged from the insertion slot 4, and some other mechanisms.

In the following, configurations and operations of a variety of drive mechanisms installed in the body frame 2A are specifically described.

### [As to Shutter Mechanism]

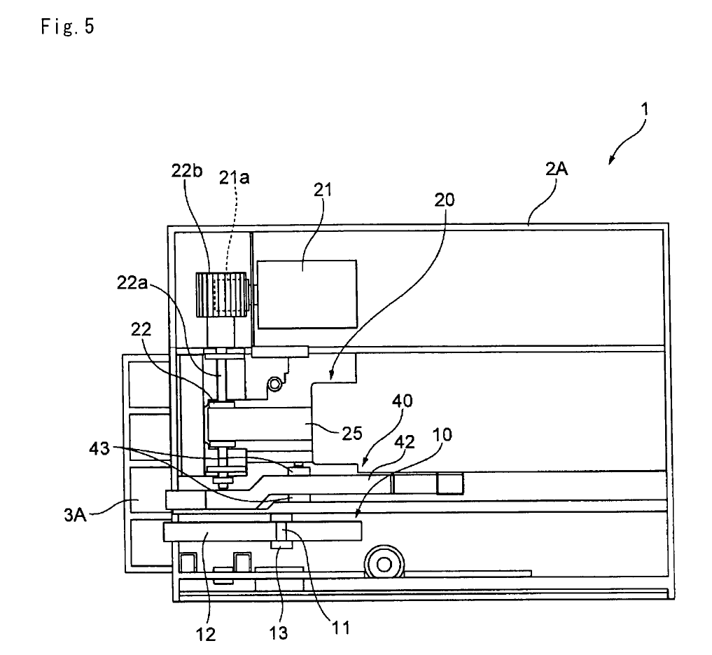

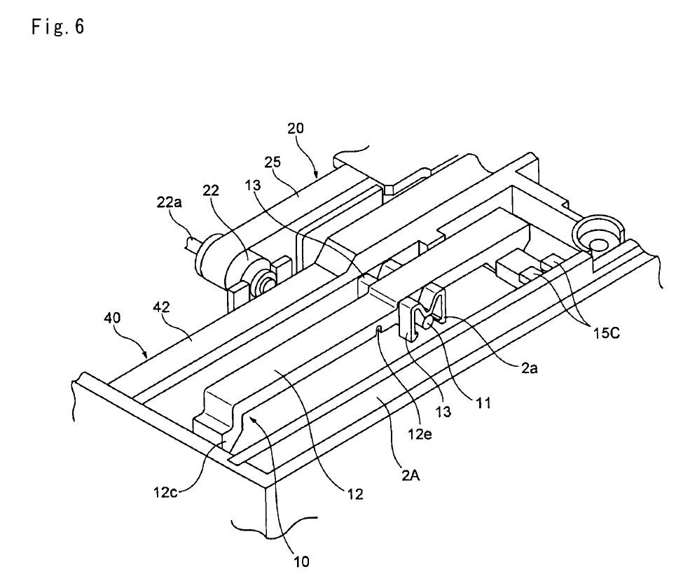

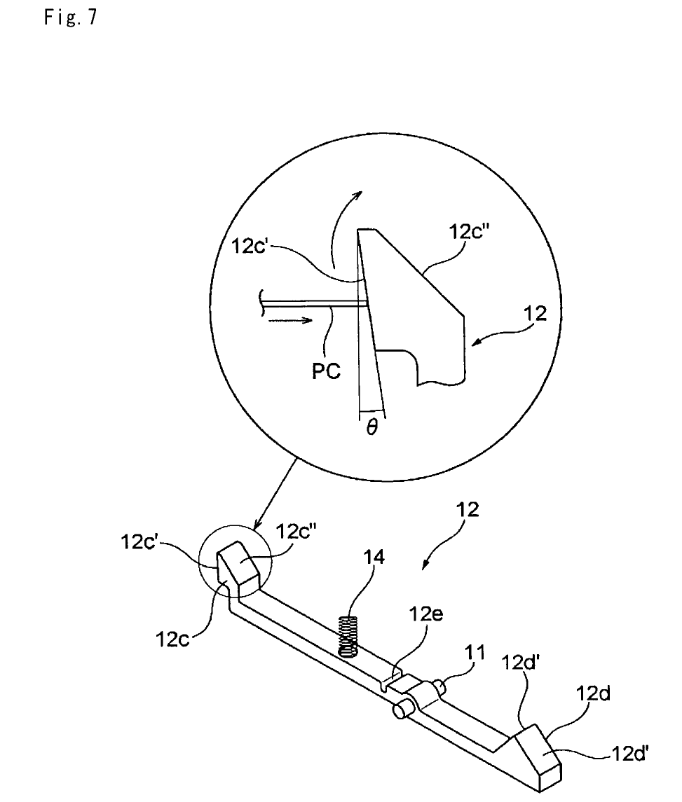

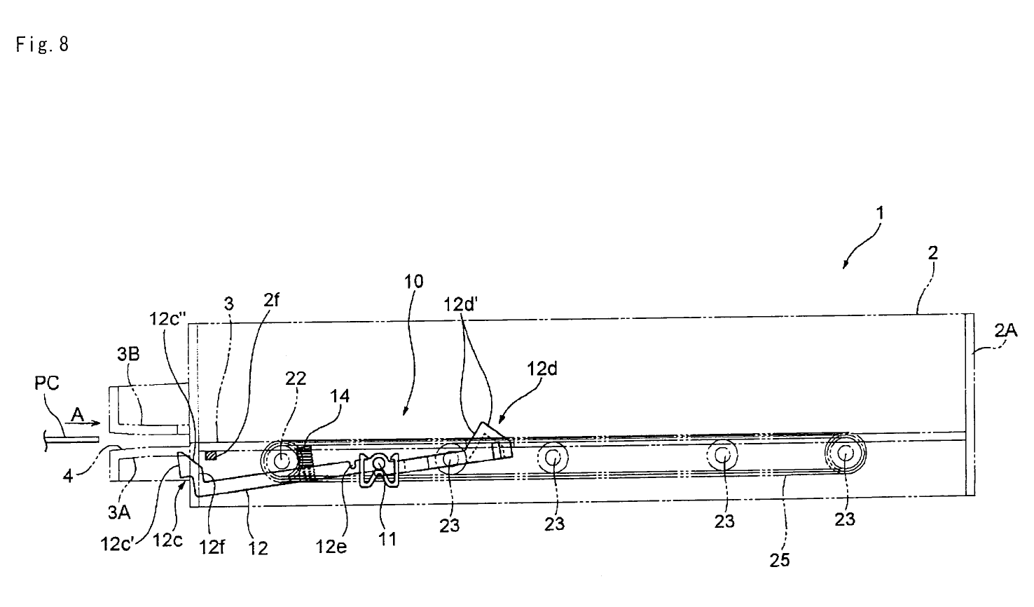

In the body frame 2A, a shutter mechanism 10 is installed which prevents the user from erroneously inserting an additional card during card processing. The configuration of this shutter mechanism 10 is described with reference to the above-mentioned FIG. 1 to FIG. 5 and FIG. 6 to FIG. 11. It is to be noted that FIG. 6 is an enlarged view of main parts of FIG. 5, FIG. 7 is a perspective view showing a configuration of an oscillating member (first oscillating member) constituting the shutter mechanism, and FIG. 8 to FIG. 11 are views sequentially showing operations of the oscillating member when a card moves from the insertion slot.

The shutter mechanism 10 has an oscillating member 12 oscillatably supported with respect to the body frame 2A via a shaft 11. The oscillating member 12 of the present embodiment is oscillatably supported on one side wall side of the carriage path 3, and extends in the card carrying direction, to be integrally formed of a synthetic resin material so as to be elastically transformed. In addition, the shaft 11 is integrally formed with the oscillating member 12 on the side slightly behind the center.

In the oscillating member 12, the shaft 11 is set to a bearing 2a projected to the rear side of the carriage path 3 of the body frame 2A, and a substantially M-shaped cover 13 is installed over the shaft 11 so that the oscillating member 12 is oscillatably supported against the body frame 2A. Namely, the oscillating member 12 can be mounted onto or demounted from the body frame 2A by a simple operation, and a load applied on the oscillating member can be alleviated by the substantially M-shaped cover 13.

Further, a closing portion 12c that makes the insertion slot 4 closable is formed on one end side of the oscillating member 12, and a projecting/withdrawing portion 12d capable of projecting and withdrawing from the carriage path 3 is formed on the other end side of the oscillating member 12. As shown in FIG. 3, the closing portion 12c is capable of projecting and withdrawing from an opening 2b formed in the vicinity of the insertion slot 4 of the body frame 2A (region of the card carrying-in portion 3A), and the projecting/withdrawing portion 12d is capable of projecting and withdrawing from an opening 2c formed on the front end side of the stock portion 2B.

The oscillating member 12 is supported such that the closing portion 12c constantly opens the insertion slot 4 (in a state where the closing portion 12c is depressed into the opening 2b), and in this state, the projecting/withdrawing portion 12d on the other end side projects from the surface of the carriage path 3. In order to give such a state, a pressing spring 14 is interposed between the oscillating member 12 at a position ahead of the shaft 11 and the rear surface of the body frame 2A, to bias the closing portion 12c in a direction to be constantly depressed into the opening 2b. A hole is formed in the oscillating member 12, and the pressing spring 14 is in the state of being held in the hole.

Further, the insertion slot side of the oscillating member 12 is arranged to be bendable along the card carrying direction. When the front end side of a card moving along the carriage path 3 presses the projecting/withdrawing portion 12d, the closing portion 12c of the oscillating member 12 in a bent state comes into contact with the surface of the rear end side of the card. Namely, with the oscillating member 12 bent, a large load is not applied to the moving card even when the closing portion 12c comes into contact therewith, thereby preventing the closing portion 12c from damaging the card and being resistance during carriage of the card.

In this case, a notch depression 12e is formed on the oscillating member 12 so that the oscillating member 12 is more easily bent when the closing portion 12c comes into contact with the moving card. This notch depression 12e is formed with a predetermined depth on the surface of the oscillating member 12 on the body frame 2A side ahead of the shaft 11, in a direction orthogonal to the shaft direction so that the closing portion 12c side can be easily bent downward. Namely, the front side including the closing portion 12c with the notch depression 12e as a supporting point can be easily bent in the direction to be depressed into the opening 2b, when the top of the closing portion 12c comes into contact with the surface of the card. It is to be noted that, other than formation of the notch depression 12e, as the means of bending the oscillating member 12, for example, the front side of the oscillating member 12 may be formed of a flexible material or the like.

Thereby, the oscillating member 12 becomes able to make the closing portion 12c and the projecting/withdrawing portion 12d formed on the respective ends thereof simultaneously come into contact with the card surface, and as shown in FIG. 8 to FIG. 11, it becomes possible to form the oscillating member 12 shorter than the length of the card in the carrying direction.

Further, as shown in FIG. 7, the closing portion 12c is formed in the shape of a substantially right-angle triangle in a side view, and has: a card insertion preventing face 12c′ rising at a substantially right angle with the carriage path 3; and an inclined face 12c′ rising toward the insertion slot 4 side. Namely, with such a shape, insertion of an additional card is reliably prevented when the insertion slot 4 is closed, and in discharge of the card from inside, smooth movement of a card is realized so that the closing portion 12c does not hinder the movement.

It is to be noted that as shown in the enlarged view in FIG. 7, the card insertion preventing face 12c′ is preferably inclined at a predetermined angle (0=the order of 5 degrees) such that the oscillating member 12 can move upward when the card PC abuts thereagainst. With such inclination formed, the oscillating member 12 is shifted upward, which is the closing direction (arrow direction), upon abutting of the card PC so as to reliably prevent insertion of an additional card.

Further, as shown in FIG. 7, an inclined face 12d′ in the shape of a substantially triangle in a side view is formed on the projecting/withdrawing portion 12d. Namely, with such a shape, when the card moves in either direction, smooth movement of the card is realized, and hence the card does not get stuck with the projecting/withdrawing portion 12d.

Moreover, in the present embodiment, as shown in FIG. 8 to FIG. 11, a contact portion 2f against which a base 12f of the closing portion 12c abuts is formed on the rear surface side of the carriage path 3 of the body frame 2A. This contact portion 2f is provided so as to come into contact with the closing portion 12c from inside when the closing portion 12c projects from the carriage path 3, thereby improving the strength of the closing portion 12c at the time of closing.

Next, an operation of the oscillating member 12 constituting the shutter mechanism 10 is described with reference to FIG. 8 to FIG. 11.

Initially, the oscillating member 12 of the shutter mechanism 10 described above is in a state where, with the shaft 11 as the center, the closing portion 12c is depressed below the carriage path 3. This state is kept by a position that the shaft 11 supports the oscillating member 12 as well as the bias force of the pressing spring 14. When the card PC is inserted from the insertion slot 4 in this state, a card detection sensor 15A (first sensor) installed on the carriage path 3 shown in FIG. 4 detects insertion of the card PC, and a drive motor constituting a later-described carriage mechanism is rotationally driven, to carry the card PC inside with the carriage belt 25.

At a stage where passage of the rear end of the carried-in card PC is detected by the first sensor 15A, the operation of the carriage mechanism is stopped to temporarily stop the card PC. FIG. 4 shows a state where the card PC has been stopped, and at this position (information processing position), a reader-writer, not shown, is driven to execute information reading/writing processing on the card PC.

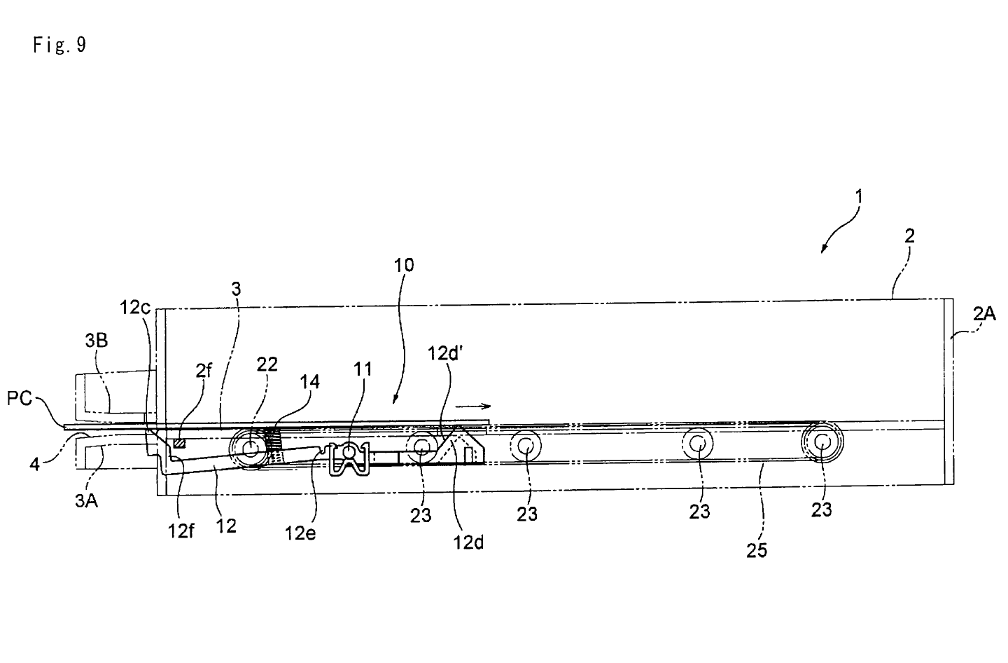

As shown in FIG. 9, when the card PC passes through the first sensor 15A and is carried by the carriage mechanism toward the information processing position, the front end of the card PC engages with the projecting/withdrawing portion 12d of the oscillating member 12, which is projecting from the opening 2c of the carriage path 3. Since, as described above, the inclined face 12d′ is formed on the projecting/withdrawing portion 12d as shown in FIG. 7, the card PC is carried further inside while shifting the projecting/withdrawing portion 12d downward.

At this time, as shown in FIG. 9, the closing portion 12c rises as the projecting/withdrawing portion 12d is pressed down, to come into contact with the card PC being carried. As described above, the oscillating member 12 is arranged to be bendable along the card PC carrying direction, and the closing portion 12c of the oscillating member 12 in the bent state comes into contact with the surface of the rear end portion side of the card. Since, as described above, the closing portion 12c side of the oscillating member 12 is easily bent downward due to the notch depression 12e and the oscillating member 12 is biased downward by bias force of the pressing spring 14, even when the closing portion 12c comes into contact with the card PC being carried, a large load is not applied to the moving card PC even when the closing portion 12c comes into contact therewith, thereby preventing the closing portion 12c from damaging the card PC and being large resistance during carriage of the card.

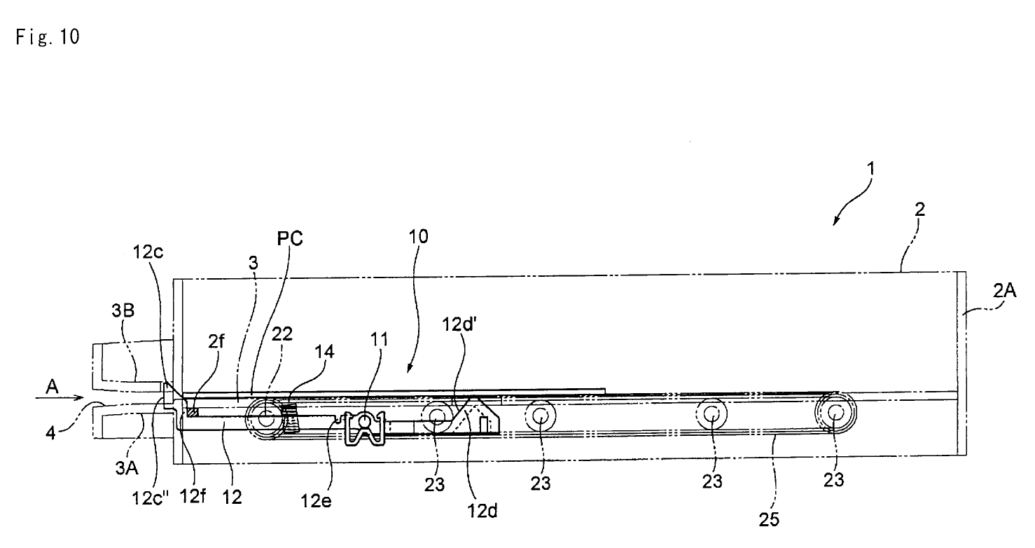

When the card PC is carried further inside and the rear end of the card passes through the first sensor 15A and is carried to the information processing position as described above, the closing portion 12c in the bent state rises as the projecting/withdrawing portion 12d of the oscillating member 12 is pressed down, to close the insertion slot 4, as shown in FIG. 10. Namely, when the card PC is carried to the information processing position, the oscillating member 12 constituting the above described shutter mechanism brings the insertion slot 4 into the state of blocking insertion of an additional card.

In the shutter closed state shown in FIG. 10, since, as described above, the base 12f of the closing portion 12c is in contact with the contact portion 2f provided on the rear surface side of the carriage path 3 of the body frame 2A, the strength of the closing portion 12c in shutter closing improves. Namely, since the closing portion 12c is in the state of being in contact with the contact portion 2f for enforcement and hence the closing intensity improves, even when the additional card is intended to be inserted, such insertion of an additional card is reliably prevented.

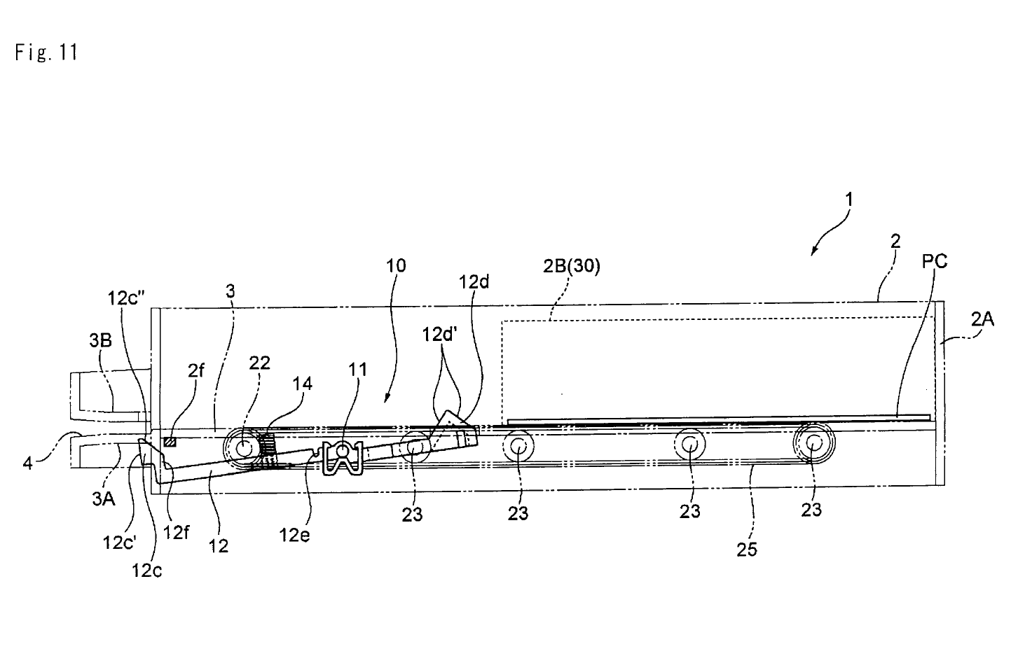

When the card PC is collected to a later-described stock portion 2B, the card PC is carried further inside to a stock position shown in FIG. 11. At this time, the rear end of the card PC leaves the projecting/withdrawing portion 12d, and the projecting/withdrawing portion 12d thereby rises. This brings the closing portion 12c on the opposite side into the state of being depressed below the carriage path 3, to constantly open the insertion slot 4. Needless to say, even after the card PC is returned to the user as it is by the carriage mechanism, the oscillating member 12 of the shutter mechanism 10 comes into the state shown in FIG. 11, where the insertion slot 4 is kept open so that a new card can be inserted.

It is to be noted that, on the carriage path 3 of the body frame 2A, a second sensor 15B is installed on the downstream side of the first sensor 15A, to detect conditions (carriage state and direction) of the card. Further, a third sensor 15C that detects an operation of the oscillating member 12 is installed on the rear surface of the body frame 2A, to detect the end of the read/write operation as well as completion of carriage of the card PC to a later-described stock portion 2B. In this case, as well known, the first sensor 15A and the second sensor 15B are each configured to have a light emitting portion and a light receiving portion which detect passage of the card, and the third sensor 15C is installed in the vicinity of the projecting/withdrawing portion 12d of the oscillating member 12 and is provided with a light-emitting portion and a light-receiving portion which detect an operation of the projecting/withdrawing portion 12d when moving up or down.

According to the above-mentioned shutter mechanism 10, when the card PC is inserted into the insertion slot 4 and then carried by the carriage mechanism, the front end side of the card engages with the projecting/withdrawing portion 12d to oscillate the oscillating member 12. With the oscillating member 12 oscillated in this manner, the closing portion 12c formed on the insertion slot side closes the insertion slot 4, thereby bringing the insertion slot 4 into the state of preventing additional insertion of a new card during the card PC processing operation. Further, even if the closing portion 12c moves in a direction to close the insertion slot 4, to come into contact with the surface of the card PC being carried before the rear end of the card passes through the insertion slot 4, contact force generated when the closing portion 12c comes into contact with the card surface is alleviated because the oscillating member 12 is configured to be bendable as described above, thereby preventing damage on the card surface. In particular, the notch depression 12e formed on the oscillating member 12 can make the oscillating member to be more bendable, to allow reliable alleviation of contact force of the closing portion 12c on the card so that damage on the card surface can be reliably prevented.

This eliminates the need for adjusting the length of the carriage direction of the oscillating member 12 based upon the length of the card in the carrying direction, thereby allowing reduction in size of the processor body. Specifically, it becomes possible to set the length of the oscillating member 12 shorter than the length of the card in the carrying direction, so as to reduce the processor body in size by the length by which the oscillating member 12 is set shorter.

It is to be noted that, as shown in FIG. 4, a wall-shaped rib 80 is projectingly formed ahead of the side of the closing portion 12c on the surface of the carriage path 3. With such a rib formed, it is possible to reliably prevent double insertion of cards even when the card is thin with respect to a gap of the carriage path 3.

### [As to Carriage Mechanism]

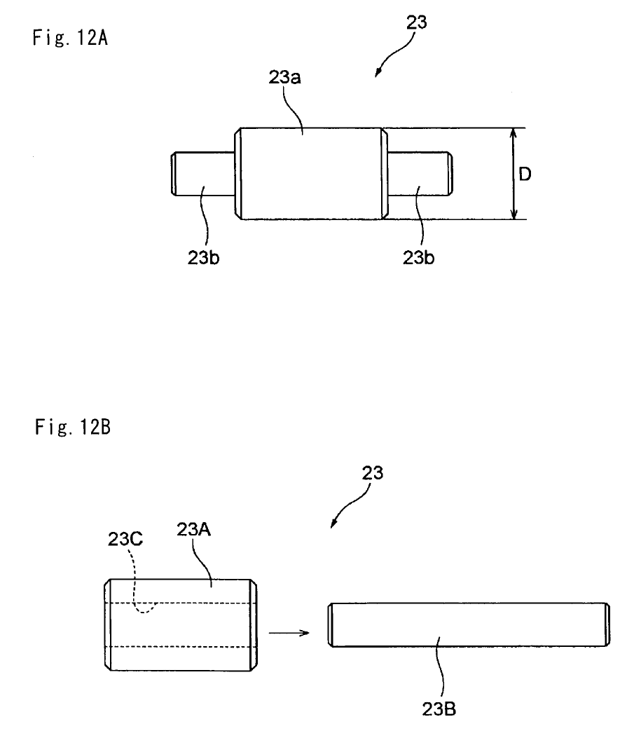

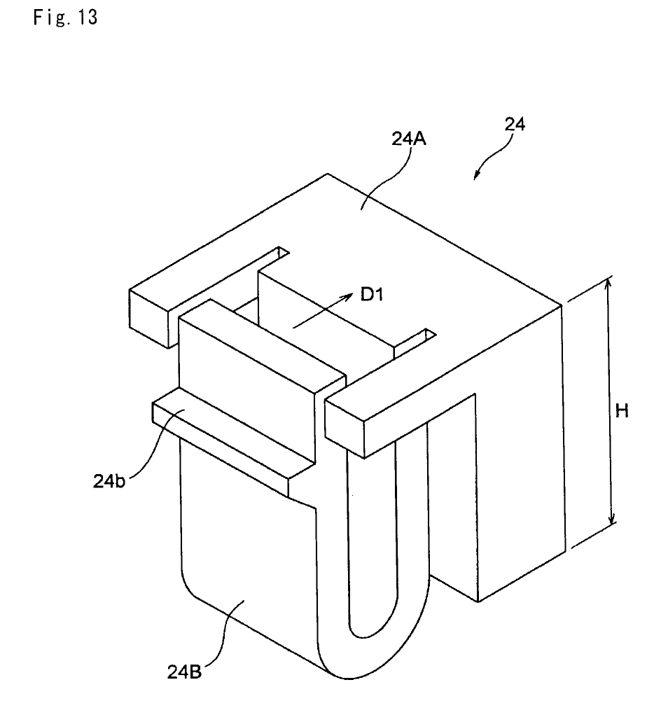

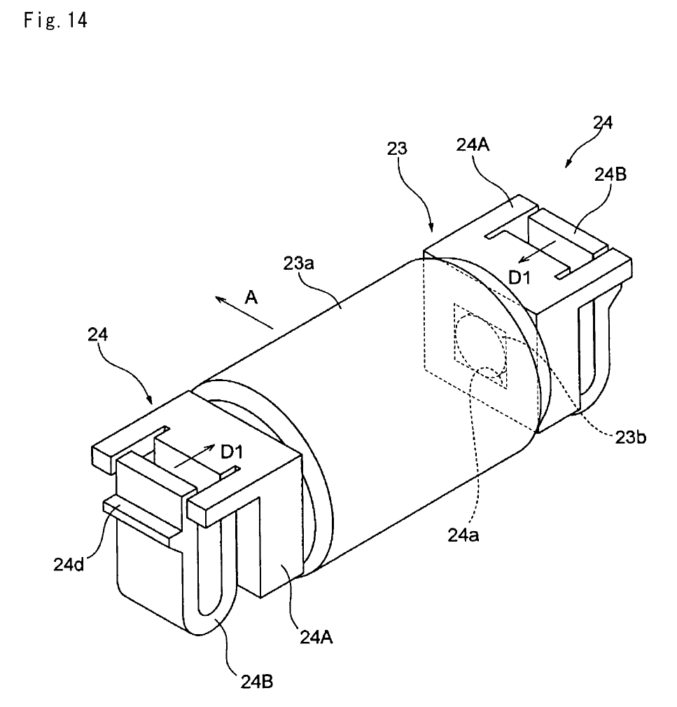

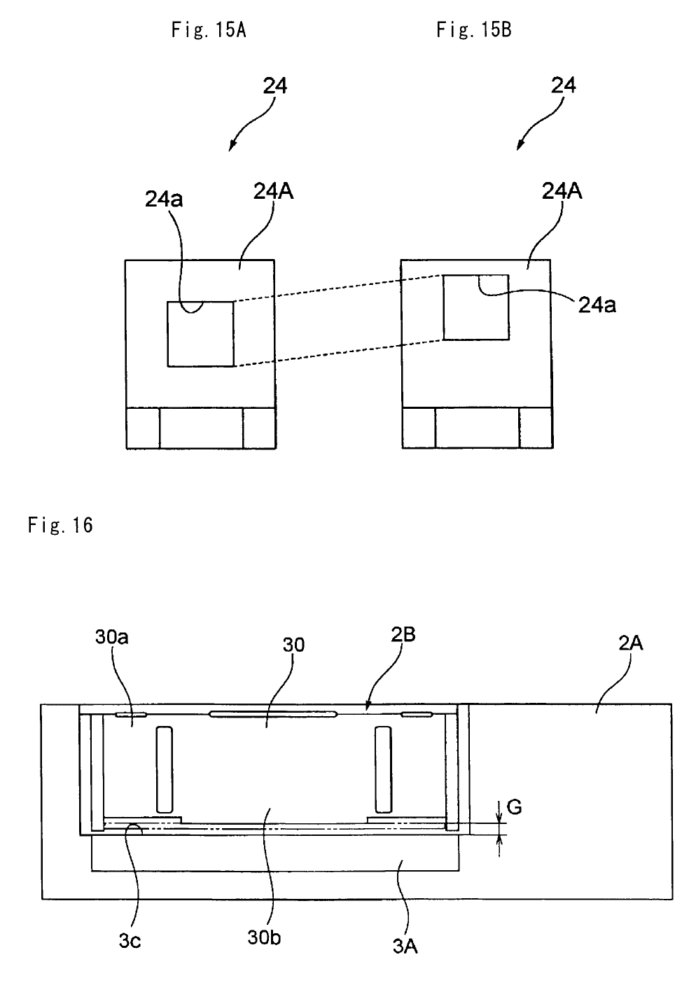

In the body frame 2A, a carriage mechanism 20 is installed which carries a card inserted into the insertion slot 4 toward the inside of the processor. The configuration of this carriage mechanism is described with reference to the above-mentioned FIG. 1 to FIG. 5 and FIG. 12 to FIG. 15. It is to be noted that FIG. 12 is a view showing a configuration of a roller, FIG. 13 is an enlarged perspective view of a fixing member that rotatably holds a roller constituting a carriage mechanism, FIG. 14 is a view showing a state where the roller is held between a pair of fixing members, and FIG. 15A and FIG. 15B are views each showing a fixing member in which the position of the central shaft holding portion has been changed.

The carriage mechanism 20 of the present embodiment is configured to be able to carry a card inserted from the insertion slot 4 along an insertion direction A and to be able to carry a card located inside the processor body toward the insertion slot 4 side. The carriage mechanism 20 is provided with: a drive motor 21 as a drive source installed on the body frame 2A (see FIG. 5); and the carriage belt 25 which is rotationally driven by the drive motor 21, to be exposed to the surface of the carriage path 3 and extends along the carriage direction.

The carriage belt 25 is wound around a rotating roller 22 installed on the drive shaft 22a rotatably driven by the drive motor 21 and a roller 23 installed at a predetermined spacing along the carriage path 3. The carriage belt 25 with its surface exposed to the carriage path 3 has the function of carrying the card placed thereon. It is to be noted that, as shown in FIG. 3, the rollers 23 are installed at four places with predetermined spacing along the carriage direction, in a substantially central region of the carriage path 3 of the body frame 2A.

As shown in FIG. 5, the rotating roller 22 is provided at the central part of a drive shaft 22a rotatably supported by the body frame 2A in a direction orthogonal to the card carrying direction. A gear 22b fixed to the end of the drive shaft 22a is meshed with an output gear 21a fixed to the output shaft of the drive motor 21, to rotationally drive the drive shaft 22a.

Further, the roller 23 in the state of being rotatably held by the fixing member 24 is installed at a predetermined position of the carriage path 3. In the following, configurations of the roller 23 and the fixing member 24 are described with reference to FIG. 12 to FIG. 14.

The roller 23 is integrally formed using a synthetic resin such as POM, and as shown in FIG. 12A, the roller 23 is provided with a column portion 23a to be wound with the carriage belt 25 and a central shaft 23b projecting at the central part of each side of the column portion 23a, the roller 23 being formed shorter than the width direction length of the card. It is to be noted that the roller 23 may have a two-piece configuration formed of a column portion 23A and a central shaft 23B as shown in FIG. 12B. Namely, the column portion 23A and the central shaft 23B are integrally formed using the synthetic resin such as POM, and the central shaft 23B is fitted into a central hole 23C formed in the column portion 23A to constitute the roller 23 so that the roller 23 can be smoothly rotated.

Further, as is the roller 23, the fixing member 24 is integrally formed using the synthetic resin such as POM, and as shown in FIG. 13 and FIG. 14, the fixing member 24 is configured to rotatably hold the central shaft 23b of the roller 23 and be installable by one-hand into the body frame 2A while in the state of holding the roller 23. Specifically, the fixing member 24 is arranged to be inserted into a depression 3a previously formed on the surface portion of the carriage path 3, and fixed thereto and provided with: a body 24A which is formed in the shape of a substantially rectangular prism and in which a central shaft holding portion 24a for rotatably holding the central shaft 23b of the roller 23 is formed; and a transforming portion 24B in substantially U-shape which is erastic-transformably integrated with the body 24A.

In FIG. 13, the transforming portion 24B is elastically transformable in an arrow direction D1, and a retaining flange 24b is integrally formed on the surface of the outside wall of the transforming portion 24B. Further, the central shaft holding portion (holding hole) 24a is in the state of being closed by the inside wall of the transforming portion 24B.

As shown in FIG. 14, a pair of fixing members 24 having the above-mentioned configuration is prepared, and the central shaft 23b on each side of the roller 23 is inserted into the central shaft holding portion (holding hole) 24a formed in the body 24A of each of the fixing members 24, and in such an incorporated state, each of the fixing members 24 is inserted (pressure-inserted) into each of the depressions 3a of the carriage path 3. As described above, the depression 3a into which the fixing member 24 can be pressure-inserted and a depression in which the held roller 23 is to be located are formed at predetermined positions on the carriage path 3, and the fixing member 24 is inserted into the depression 3a, bending the transforming portion 24B formed on the body toward the roller central side (in a direction of an arrow D1 in FIG. 14). In this inserting operation, the retaining flange 24b eventually passes over the edge of the depression 3a and the transforming portion 24B returns to its initial position, whereby the fixing member 24 comes into the state of being prevented from slipping out and held by the retaining flange 24b.

According to the above-mentioned configuration, while in the state of being held by the fixing member 24, the roller 23 constituting the carriage mechanism can be installed by a one-touch operation (a simple pressure-insertion operation) into the depression (installation portion) 3a formed on the card carriage path of the body frame 2A; thus, incorporating the rollers 23 into the body frame 2A becomes easy so that manufacturing cost can be reduced.

In particular, in the configuration of the present embodiment, the fixing member 24 is provided with the transforming portion 24B that is elastically transformable, and the fixing member 24 is arranged to be fixed such that force is applied to the transforming portion 24B in a direction (direction of the arrow D1 in FIG. 13 and FIG. 14) along the central shaft of the roller. Since the direction D1 in which the force is applied is a direction orthogonal to the direction in which the roller 23 rotates (card carrying direction A), the fixing member 24 hardly moves with rotation of the roller 23, and the fixed state of the fixing member 24 thus becomes strong. Namely, movement of the roller 23 in the card carrying direction (direction A) can be suppressed so as to realize stable card carriage.

Further, in the above-mentioned configuration, the roller 23 is held between a pair of fixing members 24, and the direction D1 in which the transforming portions 24B for removing the fixing members 24 elastically transform are directions toward the center of the roller as shown in FIG. 14. This configuration enables the transforming portions 24B of the pair of fixing members 24 to be elastically transformed by being picked up so that the pair of fixing members 24 can be removed from the body frame 2A; it is thereby possible to attempt improvement in maintenance properties.

Further, in the above-mentioned configuration, since the fixing member 24 has the central shaft holding portion 24a in which the central shaft 23b of the roller 23 is rotatably installed, only changing this position allows positional adjustment of the roller in its height direction. Namely, as shown in FIG. 15A and FIG. 15B, the position of the roller 23 can be adjusted by a simple operation performed such that a plurality of kinds of fixing members 24 with the position of the central shaft holding portion 24a changed therein are prepared and the prepared fixing members 24 are installed in the body frame 2A. This facilitates positional adjustment of the roller 23, and it is thereby possible to attempt improvement in maintenance properties.

As for the roller 23 and the fixing member 24 having the above-mentioned configurations, a diameter D of the roller 23 (column portion 23a) is preferably formed larger than dimensions of the fixing member 24, specifically a height H as the direction of pressure-insertion.

With the roller 23 and the fixing member 24 set in such a dimensional relationship, the roller 23 (column portion 23a) becomes larger in the height direction than the fixing member 24 when the roller 23 is incorporated into the fixing member 24. Therefore, when these are installed on the carriage path 3, the roller 23 projects from the carriage surface while the surface position of the carriage belt 25 wound around the roller 23 can also be higher than the position of the fixing member 24. Therefore, it is possible to prevent the card carried to the carriage path 3 from coming into contact with the fixing member 24 so as to reliably prevent clogging with the card, and the like.

As shown in FIG. 2, the pinch rollers 101, 102 installed on the substrate mounted frame 2C are oppositely arranged at positions of the rotating roller 22 and the roller 23 installed on the insertion slot side, and a card inserted into the insertion slot 4 is carried through a nip portion between the pinch rollers 101, 102 and the carriage belt 25. Further, as shown in FIG. 2, a pressure plate on which the card PC is to be placed (the card placed on the pressure plate) is arranged to be opposed to positions of three rollers 23 on the downstream side, when the stock portion 2B is closed.

### [As to Stock Portion, Housing Drive Mechanism, and the Like]

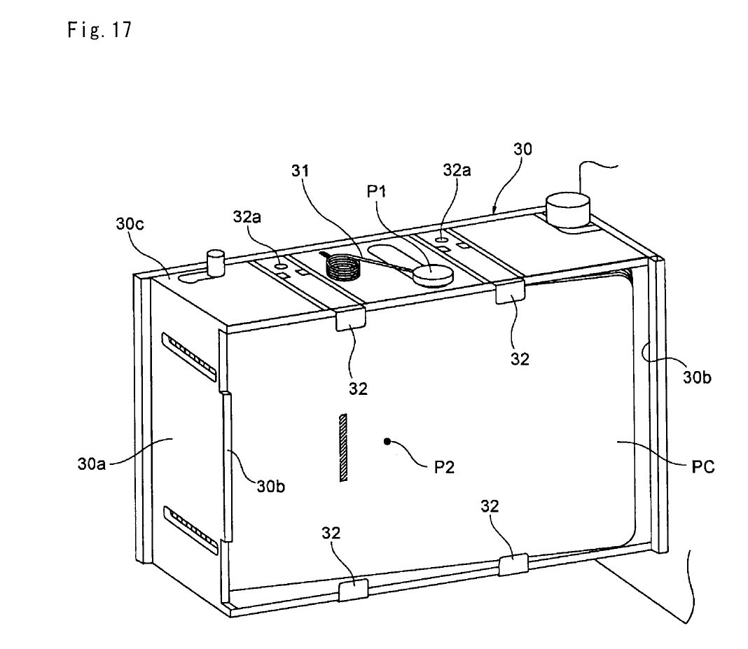

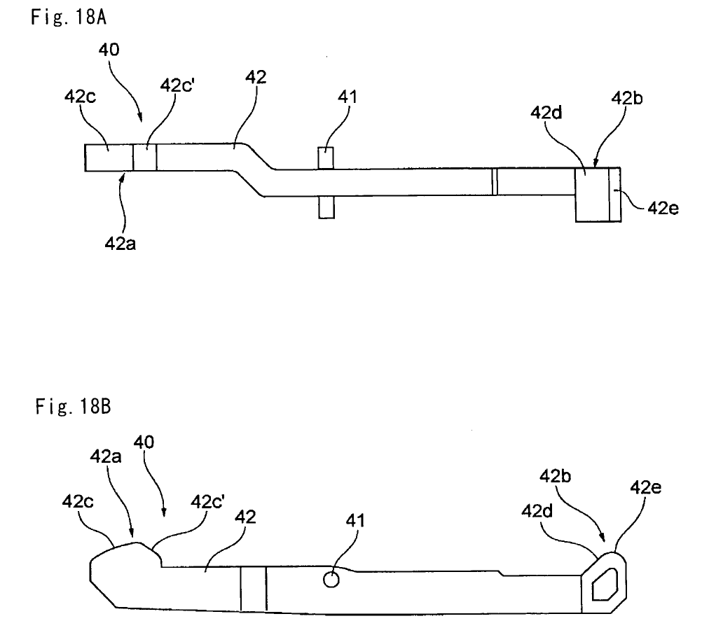

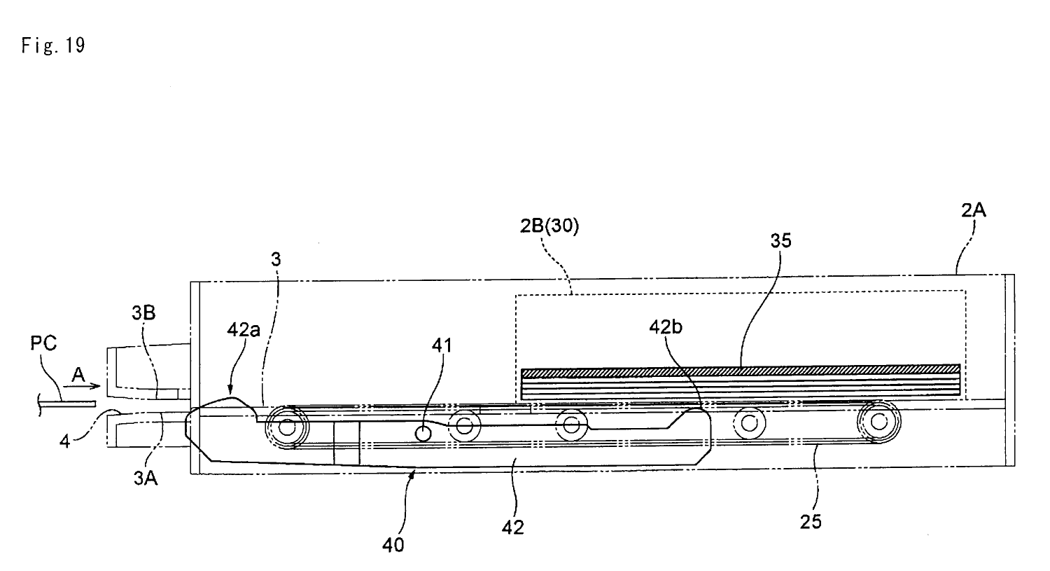

In the body frame 2A, there are installed: the stock portion 2B that collects a fully used card and houses a card to be issued according to need; and a housing drive mechanism 40 that is activated so as to house a card into the stock portion 2B. The configurations of these stock portion 2B and housing drive mechanism 40 are described with reference to the above-mentioned FIG. 1 to FIG. 6 and FIG. 16 to FIG. 25. It is to be noted that FIG. 16 is a view of a stock portion seen from the insertion slot side, FIG. 17 is a view showing a state where a card is housed in the stock portion, FIG. 18A is a plan view showing a configuration of an oscillating member (second oscillating member) that constitutes a housing drive mechanism, FIG. 18B is a side view thereof, and FIG. 19 to FIG. 25 are views sequentially showing functions of the second oscillating member and the stock portion associated with carriage of the card.

As described above, the stock portion 2B is rotatably arranged on the base installed on the back side of carriage direction, with respect to the body frame 2A, and is typically in a closed state as shown in FIG. 1.

The stock portion 2B is provided with a body 30 formed in box shape so as to house a predetermined number of cards PC (the order of ten cards in the present embodiment). As shown in FIG. 16 and FIG. 17, a wall portion (front wall) 30a on the insertion slot side of the body 30 is formed in the shape of a substantial projection seen from the insertion slot side; when the body 30 is closed into the body frame 2A, a gap G through which one card can pass is formed between the body 30 and the surface 3c of the carriage path 3. A projecting portion 30b is formed on the front wall 30a, and in issuing a card from the stock portion 2B (body 30), only a card on the carriage path 3 surface side (top card) can be discharged because cards under the first card abut against the projecting portion 30b.

It is to be noted that cards stacked and housed inside the body 30 are in a state where the top card is in surface contact with the above-mentioned carriage belt 25 of the carriage mechanism.

Inside the body 30, a pressure plate 35 (schematically shown in FIG. 19 to FIG. 25) having substantially the same dimensions as those of the opening of the body 30 is arranged, and this pressure plate 35 is in the state of being constantly biased to the carriage path side by a bias spring 31 installed on each sidewall 30c of the body 30. In this case, an attachment position P1 of the bias spring 31 pressing the pressure plate 35, with respect to the pressure plate is set to the central position of the longitudinal direction (card carrying direction) of each side wall 30c of the body 30. As thus described, installation of the bias spring 31 that presses the pressure plate 35 at the central position of each side wall 30c permits application of stable pressure to the pressure plate 35, and allows an increase in number of cards to be housed as compared with the configuration in which a pressure spring is installed inside the body 30.

Further, each side wall 30c of the body 30 is provided with two nails 32, which hold the card PC so as to prevent dropping thereof, at a predetermined spacing in the longitudinal direction. The nail 32 is formed by bending in L shape the front end side of a rectangular fitting 32a that is attached to the surface side of each wall portion 30c.

In the above-mentioned body frame 2A, the housing drive mechanism 40 is installed, which, when a card inserted from the insertion slot is fully used, cooperates with the card carrying operation performed by the carriage belt 25, to house the card into the body 30 of the stock portion. This housing drive mechanism has the function of performing a press-up operation on the pressure plate 35 in housing a card without installation of an electric component. In the following, the configuration of the housing drive mechanism 40 is described.

The housing drive mechanism 40 has the oscillating member 42 (hereinafter referred to as a second oscillating member 42 to be distinguished from the oscillating member 12 of the shutter mechanism described above) oscillatably supported via a shaft 41 with respect to the body frame 2A. As shown in FIG. 3, the second oscillating member 42 of the present embodiment extends in the card carrying direction, and is oscillatably supported by the rear surface side of the carriage path 3 more inside of the carriage path 3 (center line side) than the above-mentioned oscillating member 12. The second oscillating member 42 is integrally formed, and the shaft 41 is provided on the side slightly behind the center.

As shown in FIG. 5, the shaft 41 is installed with respect to the supporting portion projecting on the rear surface side of the carriage path 3 of the body frame 2A, and a cover 43 is installed over the shaft 41 so that the second oscillating member 42 is oscillatably supported at the body frame 2A. Namely, as is the oscillating member 12, the second oscillating member 42 can be mounted or demounted from the body frame 2A by a simple operation.

On this second oscillating member 42, there are integrally formed a first projecting/withdrawing portion 42a that can project and withdraw from the surface of the carriage path 3 on the insertion slot 4 side and a second projecting/withdrawing portion 42b that can project and withdraw from the surface of the carriage path 3 on the stock portion 2B side. As shown in FIG. 3, the first projecting/withdrawing portion 42a can project and withdraw from an opening 2g formed in the vicinity of the insertion slot 4 of the body frame 2A, specifically between the insertion slot 4 and the carriage mechanism 20. The second projecting/withdrawing portion 42b can project and withdraw from an opening 2h formed at the central position of the stock portion 2B.

In this case, the second oscillating member 42 and the opening 2h are configured so that the second projecting/withdrawing portion 42b can come into contact with a position slightly more upstream side than a central position P2 of the card PC housed in the body 30 (the contact position is indicated by virtual slant lines). Therefore, as shown in FIG. 18A, the second projecting/withdrawing portion 42b has a shape extended in the width direction as compared with the first projecting/withdrawing portion 42a. It is to be noted that, although the second oscillating member 42 is formed by being bent at the central region in relation to an installation space and an arrangement position of the carriage belt as shown in FIG. 18A, the shape of the second oscillating member 42 can be transformed as appropriate so long as allowing the second projecting/withdrawing portion 42b to come into contact with the position slightly more upstream side than the central position P2 of the card PC housed in the body 30.

An inclined face gradually rising toward the card carrying direction is formed on the first projecting/withdrawing portion 42a, being configured to allow smooth movement of the card. Since it is configured in the present embodiment that the card PC is inserted inside from the insertion slot 4 and discharged (issued) from inside via the insertion slot 4, inclined faces 42c, 42c′ gradually rising toward the respective carriage directions are formed on the respective surface sides of the first projecting/withdrawing portion 42a. It is to be noted that, as described later, the first projecting/withdrawing portion 42a has a function as the drop prevention mechanism, preventing dropping of a card to be discharged from the insertion slot 4. The aspect of holding a card by this first projecting/withdrawing portion 42a (holding portion) is described later.

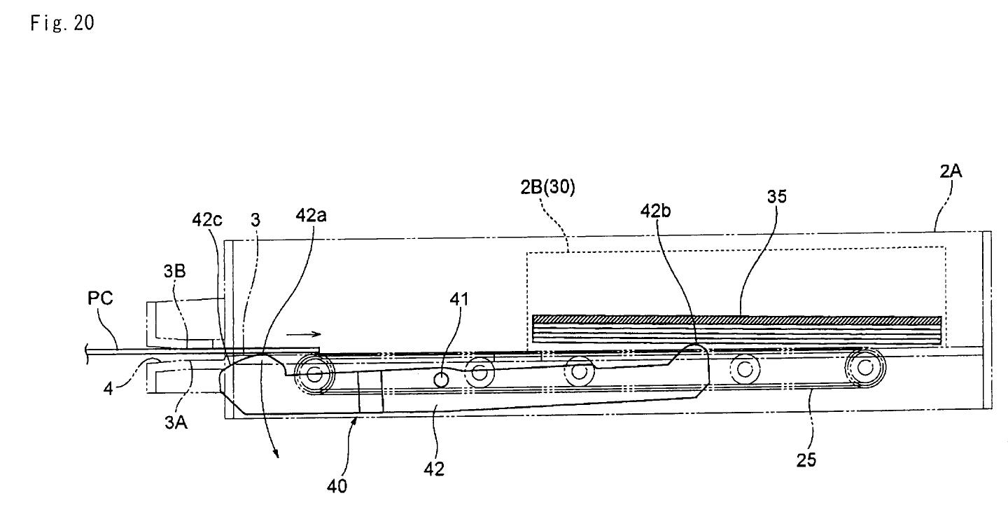

Further, an inclined face 42d gradually rising toward the card carrying direction is also formed on the second projecting/withdrawing portion 42b to allow smooth movement of the card inserted from the insertion slot 4. The inclined face 42d is formed on the surface on the insertion slot side. A top 42e of the inclined face abuts against the pressure plate 35 of the body 30 (the top card, in a case where the cards PC are stacked and housed on the pressure plate) following the oscillating operation of the second oscillating member 42, to incline the pressure plate 35 so that the insertion slot side of the pressure plate 35 rises to form a gap, as shown in FIG. 20.

It is to be noted that the second oscillating member 42 is typically supported in a state where the first projecting/withdrawing portion 42a projects from the surface of the carriage path 3, and the second projecting/withdrawing portion 42b abuts against the pressure plate (or a card stacked thereon).

Further, in the body frame 2A, a fourth sensor (not shown) is installed which detects the state of the pressure plate 35 in the body 30, to detect whether or not a card is housed inside the body 30.

Next, the functions of the second oscillating member 42 and the stock portion 2B associated with carriage of a card are described with reference to FIG. 19 to FIG. 25.

In an initial state, the second oscillating member 42 of the housing drive mechanism 40 is in a state where the projecting/withdrawing portions 42a, 42b on the respective sides project from the carriage path 3, with the shaft 41 as the center. The second projecting/withdrawing portion 42b is in the state of being in contact with the top card in the stock portion 2B.

When the card PC is inserted from the insertion slot 4 in this state, the card detection sensor (first sensor) 15A installed on the carriage path 3, shown in FIG. 4, detects the insertion, and the drive motor constituting the carriage mechanism is rotationally driven; then, as shown in FIG. 20, the card PC is carried inside by the carriage belt 25. At this time, since the card PC presses down the first projecting/withdrawing portion 42a via the inclined face 42c, the second oscillating member 42 is turned counterclockwise with the shaft 41 as the center, and the second projecting/withdrawing portion 42b in contact with the top card stacked and housed presses up the pressure plate 35 against bias force of the bias spring 31. Since the second projecting/withdrawing portion 42b is in contact with a position slightly more upstream side than the central position P2 of the card PC as shown in FIG. 17, the pressure plate 35 is inclined with its upstream side rising, as shown in FIG. 20. Therefore, the card PC carried by the carriage belt 25 smoothly enters inside the body 30 of the stock portion 2B through the gap G shown in FIG. 16.

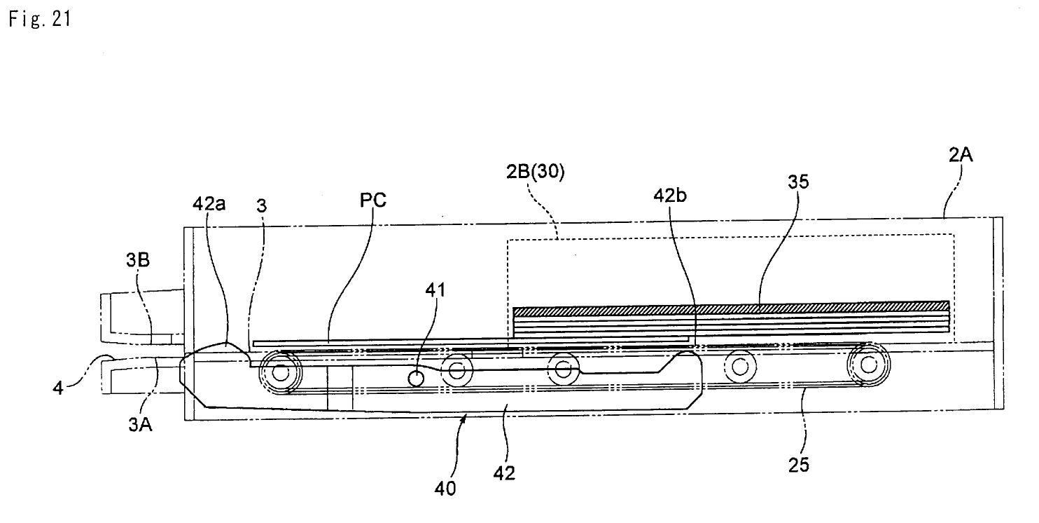

At the stage where passage of the rear end of the card PC to be carried in is detected by the first sensor 15A, the operation of the carriage belt 25 is stopped to temporarily stop the card PC (see FIG. 4 and FIG. 21). As described above, the reader-writer, not shown, is driven at this position (information processing position), to execute reading/rewriting of information on the card PC. At this time, the front end of the card PC is located immediately before the second projecting/withdrawing portion 42b.

After the information reading/writing processing on the card PC, the card PC is housed into the stock portion 2B as it is when no credit is left in the card PC, and returned to the user when a credit is left in the card PC.

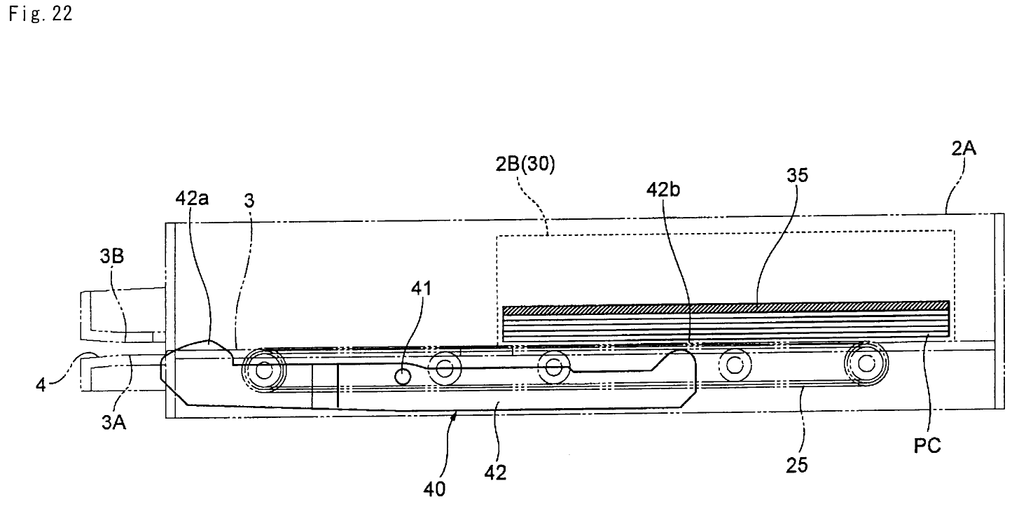

Specifically, in the state shown in FIG. 21, when the reader-writer determines that no credit is left in the card PC, the carriage belt 25 is rotationally driven so as to continuously carry the card PC to the body 30 of the stock portion 2B. Subsequently, the operation of the carriage belt 25 is stopped at a stage where the card PC is carried to a position shown in FIG. 22, and the card PC is then stacked and housed on the pressure plate 35 inside the body 30. On the other hand, when a credit is left in the card PC, the carriage belt 25 is counter-driven to return the card PC to the user. At this time, as described above, the card PC discharged from the insertion slot 4 is held in the state of projecting from the insertion slot 4 by the first projecting/withdrawing portion 42a provided with the function as the holding portion. It is to be noted that processing of holding the card PC in the state of projecting from the insertion slot 4 is the same as processing of issuing a card from the stock portion 2B described below.

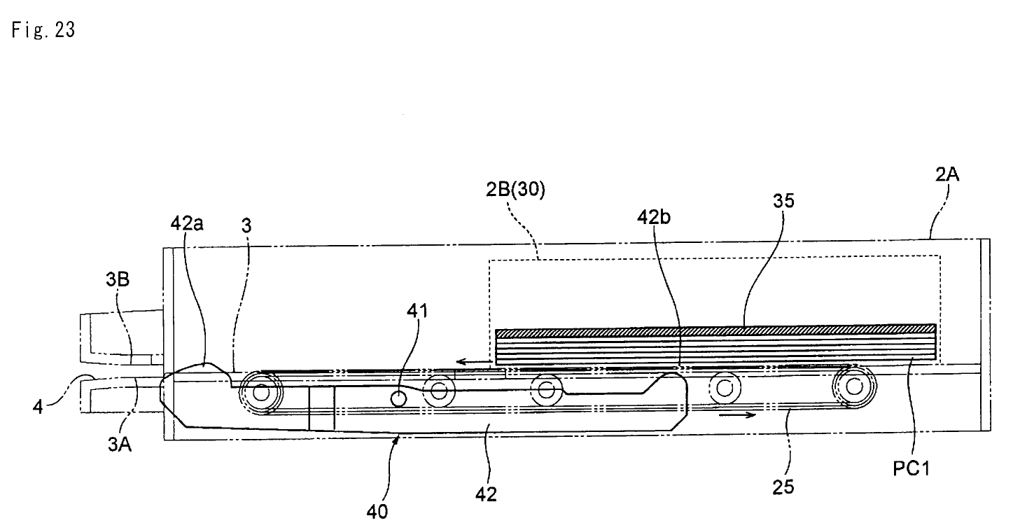

Here, the processing of issuing a card is described with reference to FIG. 23 to FIG. 25.

For example, in a case where a bill is inserted into a bill processor that is not shown and a card PC with its amount-of-money information written therein is issued, as shown in FIG. 23, a top card PC1 (card in contact with the carriage belt 25) among cards stacked and housed in the stock portion 2B is issued. Namely, the top card PC1 is in the state of being pressed onto the carriage belt 25 by a bias force functioned on the pressure plate 35, and the carriage belt 25 is rotationally driven in this state so that the card PC1 is carried toward the insertion slot 4 side.

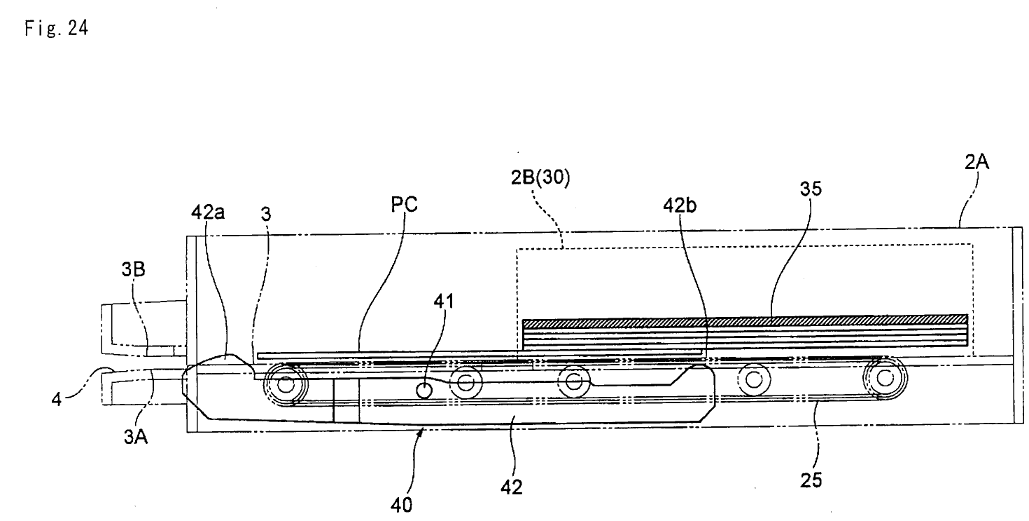

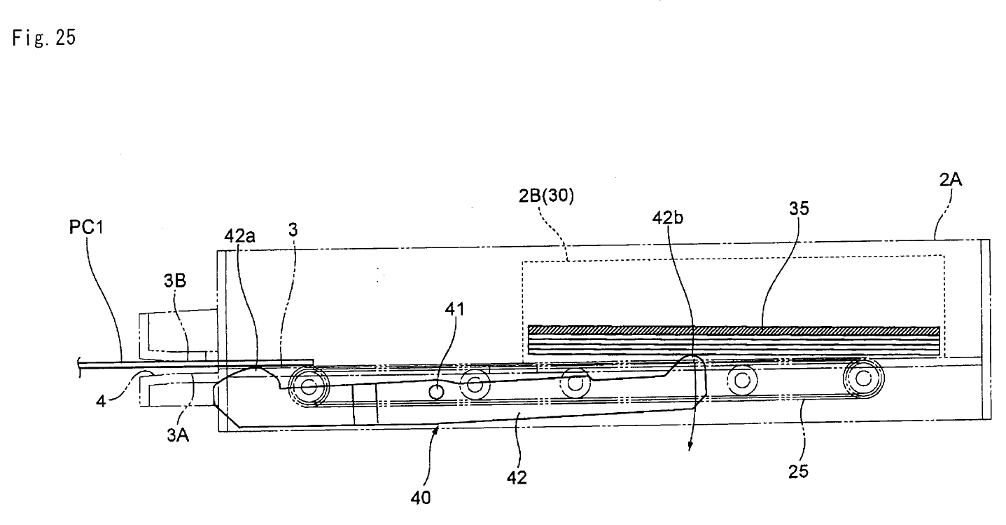

In this carriage process, the card PC1 is temporarily stopped at an information processing position shown in FIG. 24, and the reader-writer is driven at this position so that predetermined information is written. When this writing processing is finished, the carriage belt 25 is again rotationally driven, to discharge the card PC1 from the insertion slot 4. At this time, the operation of the carriage belt 25 is stopped when the card to be discharged comes to a predetermined position, specifically a position where the first projecting/withdrawing portion 42a of the second oscillating member 42 comes into contact with the end region of the card PC1, as shown in FIG. 25. It is possible to control stopping of the carriage belt 25 operation for example by detection of the rear end of the card PC1 by the second sensor 15B shown in FIG. 4, passage of predetermined time from detection of rotation of the oscillating member 12 by the third sensor 15C shown in FIG. 6, or the like.

According to the second oscillating member 42 configured as described above, when a card is inserted into the insertion slot 4, the first projecting/withdrawing portion 42a is pressed down and the second projecting/withdrawing portion 42b thereby rises to press up cards housed in the stock portion 2B located above the second projecting/withdrawing portion 42b, allowing the card carried in to be stacked and housed inside the body 30. Since just oscillating the second oscillating member 42 associated with the card carrying operation allows a card to be stacked and housed in the stock portion 2B, the configuration of the housing drive mechanism is simplified without providing a drive component, such as a motor or a cam, and an electrical component as has conventionally been done. Therefore, destabilization of an operation to house a card into the stock portion due to a broken drive component or the like is also suppressed.

Further, as described above, with the operation of the carriage belt 25 for carrying the card PC1 thereon in a stopped state, the first projecting/withdrawing portion 42a of the second oscillating member 42 is provided with a function as the drop prevention mechanism which stops and holds a card so as not to drop from the insertion slot 4.

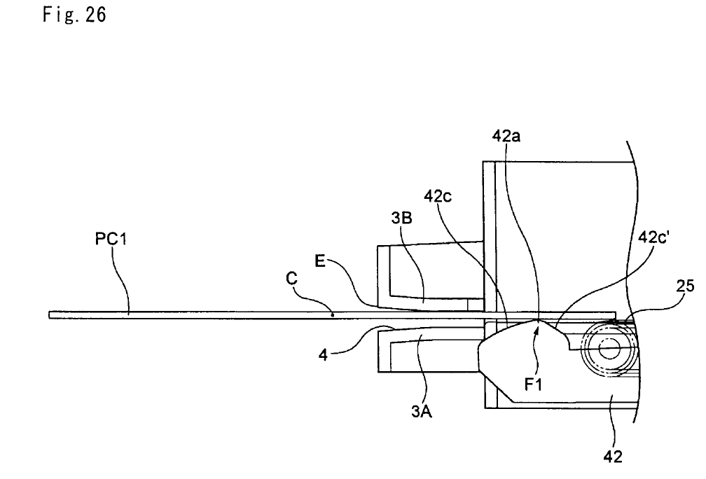

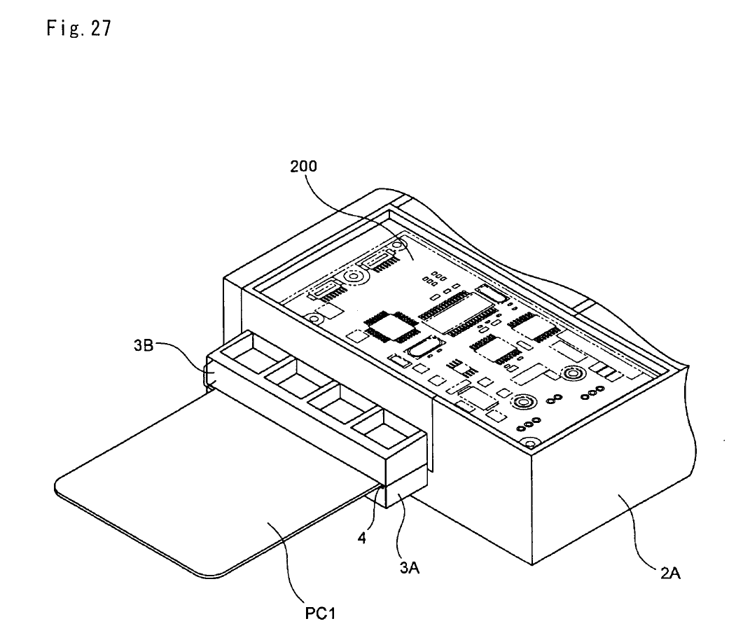

Namely, as shown in FIG. 25, the second projecting/withdrawing portion 42b of the second oscillating member 42 is in a state where pressure force downward as indicated by an arrow functions by the pressure plate 35. Since the second oscillating member 42 is oscillatably supported with the shaft 41 as the center, the first projecting/withdrawing portion 42a comes into a state where pressure force upward (pressure force F1 that presses up the card PC1 in the stopped state from the rear side as shown in FIG. 26) functions. At this time, since the card PC1 is in a state where its front end has been discharged from the insertion slot 4 and its upper surface abuts against the card carrying-in portion 3B as shown in FIG. 27, it is possible to hold the card PC1 in a stable state without dropping even when a center C of the card PC1 is in the state of having been discharged from an opening end E of the insertion slot 4. In this state, the card PC1 is easy for the user to pick up since half of the length direction of the card PC1 or more projects.

Further, as described above, arrangement of the first projecting/withdrawing portion 42a (holding portion) between the insertion slot 4 and the carriage belt 25 constituting the carriage mechanism eliminates the need for considering a space inside the processor body for holding the card PC1 to be discharged, allowing reduction in size of the processor body. Particularly in the present embodiment, such a holding portion is provided as another function of the second oscillating member 42 constituting the foregoing housing drive mechanism 40, whereby it is possible to reduce the number of components to simplify the configuration so as to reduce cost.

Moreover, the above-mentioned first projecting/withdrawing portion 42a has the inclined face 42c′ gradually rising toward the card carrying direction, thereby allowing smooth movement of a card passing through the first projecting/withdrawing portion 42a, to facilitate the card discharging operation.

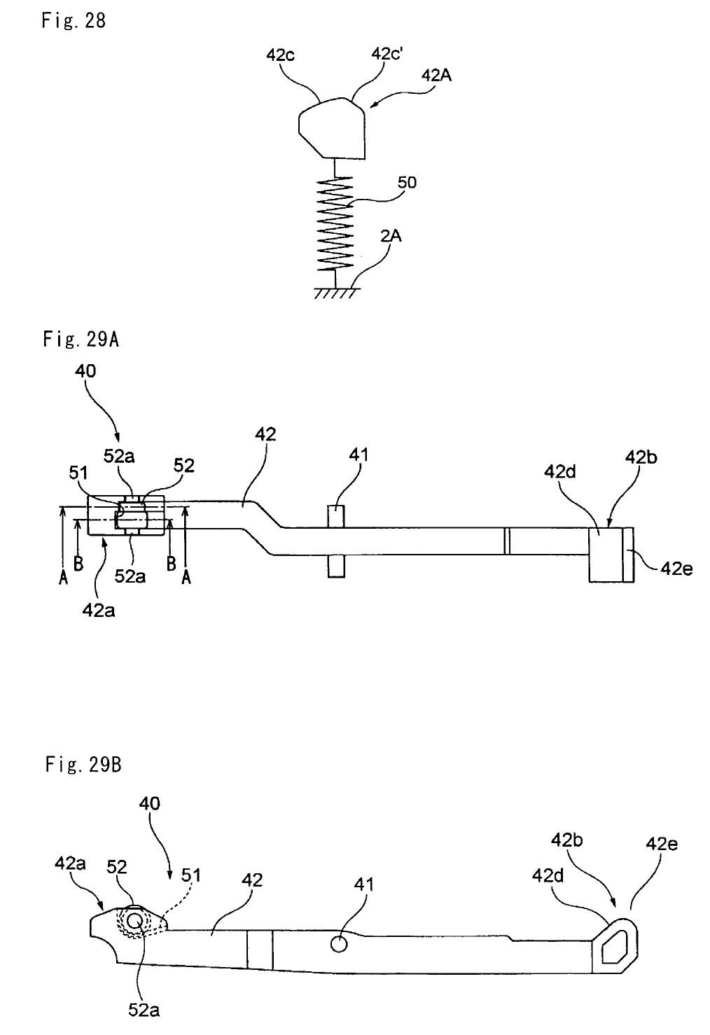

It is to be noted that the foregoing holding portion (first projecting/withdrawing portion 42a) that holds a card is not limited so long as the holding portion is configured to be installed between the insertion slot 4 and the carriage mechanism 20, press a card to be discharged, and make this card abut against the inside region of the opening portion of the insertion slot 4 for holding the card. Therefore, for example, the holding portion may be configured of a projecting/withdrawing member 42A that projects and withdraws from the carriage path 3 by a bias spring 50 as shown in FIG. 28 at the position of the first projecting/withdrawing portion 42a, without having the combined function of the housing drive mechanism 40 of the stock portion 2B described above.

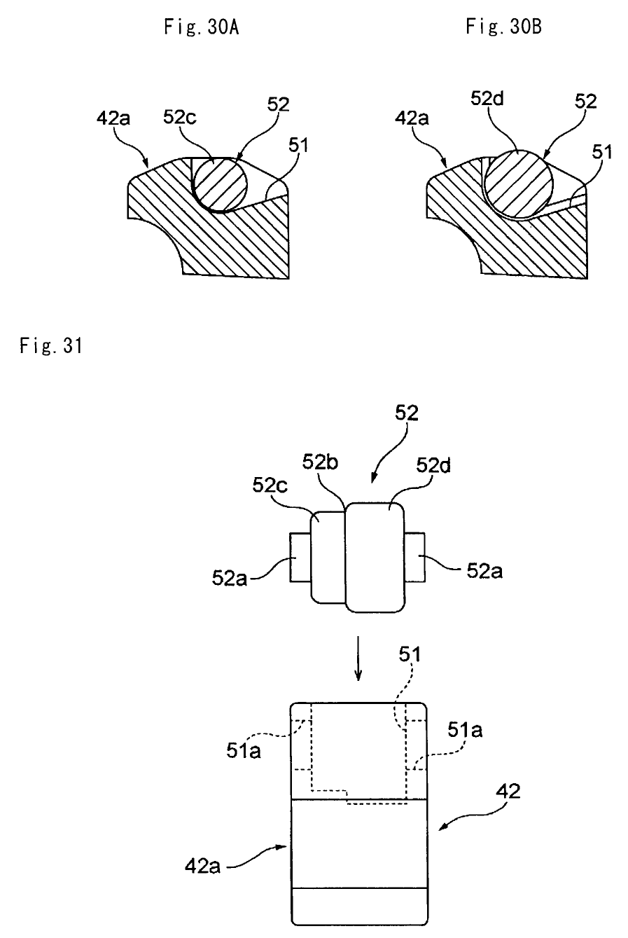

Alternatively, the foregoing first projecting/withdrawing portion 42a (holding portion) of the second oscillating member 42 may be configured as shown in FIG. 29 to FIG. 31. In these figures, FIG. 29A is a plan view showing a configuration of the second oscillating member, FIG. 29B is a side view thereof, FIG. 30A is a cross-sectional view along the line A-A of FIG. 29A, FIG. 30B is a cross-sectional view along the line B-B of FIG. 29A, and FIG. 31 is a front view of a second oscillating member, as well as a view showing the state of incorporating a roller.

Although it was configured in the foregoing embodiment that the inclined faces 42c, 42c′ gradually rising toward the respective face sides of the first projecting/withdrawing portion 42a are formed and a card is smoothly carried due to these inclined faces, the first projecting/withdrawing portion 42a may be configured that a rotating roller is supported in place of such inclined faces. Specifically, a depression 51 is formed on the first projecting/withdrawing portion 42a formed at the front end of the second oscillating member 42, and at this portion, a roller 52 is rotatably supported. The roller 52 is integrally formed of a material that does not damage a card to come into sliding contact with, such as POM, and a shaft portion 52a projecting at both ends of the roller 52 is arranged in a supporting portion 51a formed inside the depression 51 so that the roller 52 is rotatably supported by the first projecting/withdrawing portion 42a.

As just described, installation of the rotatable roller 52 in the first projecting/withdrawing portion 42a leads to smoother carriage of a card as well as reduction in contact resistance to the card, thereby allowing effective prevention of damage on the card. Further, the card can also be held between such a roller 52 and the card carrying-in portion 3B by the roller 52.

Moreover, a step 52b is formed at a substantially central portion of the roller 52, and thereby the periphery of the roller is configured to have a small diameter portion 52c and a large diameter portion 52d. In this case, the roller 52 is supported inside the depression 51 such that the small diameter portion 52c side is located outside the width direction of the carriage path. With such a step portion 52b previously formed on the roller 52, it is possible to prevent the card surface from partially coming into contact with the region of the small diameter portion 52c when the card is carried (see FIG. 30A). Namely, the surface of the card may be provided with a column to write a name in at a previously determined position, and in a roller without a step, part of the name may be rubbed and thus erased, but previously forming a step to provide a small diameter portion as just described allows the card to be protected such that the name is not rubbed and thus erased.

Although the embodiments of the present invention have been described above, the present invention is not restricted to the above-mentioned configurations, but can be variously transformed. For example, control means of controlling a carriage operation in carrying a card (configuration and arrangement aspect of a sensor that controls drive timing of the carriage mechanism, and the like) can be transformed as appropriate. Further, the configuration of the body in the stock portion, the shape of each oscillating member, the arrangement aspect of the roller constituting the carriage mechanism, and the like, can also be transformed as appropriate.

The card processor of the present invention is not restricted to a game media lending machine, but can be incorporated into a variety of devices that provide commercial products and service. Further, the card processor of the present invention is configured to comprise the stock portion that collects a card and allows issuance of a card, but is also applicable to a card processor where, simply, a card is inserted, its information is read and the card is then discharged, or a device that issues a prepaid card.

What is claimed as new and desired to be secured by Letters Patent of the United States is:

1. A card processor comprising:
an insertion slot, into which a card is inserted;
a carriage path, along which the card inserted from said insertion slot is carried; and
a shutter mechanism driven to make said insertion slot closable,
wherein
said shutter mechanism includes an oscillating member oscillatably supported by a shaft, said oscillating member having a closing portion, formed on one end side, configured to make said insertion slot closable and a projecting/withdrawing portion, formed on the other end side, configured to be able to project and withdraw from said carriage path, and
said oscillating member is bendably formed along a card carrying direction, and said closing portion of said oscillating member in a bent state comes into contact with the surface on the rear end side of the card when the front end side of the card moving along said carriage path presses said projecting/withdrawing portion.

2. The card processor according to claim 1,
wherein
the length of said oscillating member is set shorter than the length of the card in the carrying direction.

3. The card processor according to claim 1,
wherein
a notched depression is formed between said closing portion and said projecting/withdrawing portion in said oscillating member.

4. The card processor according to claim 1, further comprising a carriage mechanism which carries a card on said carriage path,
wherein
said carriage mechanism is capable of carrying the card toward the insertion slot side, and
an inclined face rising toward the insertion slot side is formed on said closing portion.

5. The card processor according to claim 1,
wherein
said carriage path has a contact portion that comes into contact with said closing portion from inside, when said oscillating member closes the insertion slot.
